(19) United States
(12) Patent Application Publication
(10) Pub. No.: US 2010/0047536 A1
(43) Pub. Date: Feb. 25, 2010

(54) LASER ETCHING OF POLYVINYLCHLORIDE

(76) Inventors: Bonifacio Del Mundo, South Elgin, IL (US); James Pfau, Kirkland, IL (US); Henry Coghlan, Elburn, IL (US)

Correspondence Address: BERENATO & WHITE, LLC, 6550 ROCK SPRING DRIVE, SUITE 240, BETHESDA, MD, 20817, US

(21) Appl. No.: 12/543,762

(22) Filed: Aug. 19, 2009

Related U.S. Application Data
(60) Provisional application No. 61/090,798, filed on Aug. 21, 2008.

(51) Int. Cl. B32B 3/10; C08L 27/14; C23F 1/02

(52) U.S. Cl. 428/195.1; 524/567; 264/400

(57) ABSTRACT

A laser-markable polyvinylchloride composition is provided which is adapted to undergo reduced or no color change in response to irradiation with a laser beam. The composition contains polyvinylchloride and a discoloration control additive present in an effective amount to reduce or eliminate discoloration caused by laser marking of the polyvinylchloride composition.

### CROSS-REFERENCE TO RELATED APPLICATION AND CLAIM OF PRIORITY

This application claims the benefit of priority under 35 U.S.C. §119(e) to U.S. Provisional Patent Application No. 61/090,798 filed Aug. 21, 2008 entitled “Laser Etching of Polyvinylchloride,” the complete disclosure of which is incorporated herein by reference at to which priority is claimed.

### FIELD OF THE INVENTION

The present invention relates to methods of laser marking of an article surface made of polyvinylchloride with reduced discoloration, and to laser-markable polyvinylchloride compositions and laser-marked articles.

### BACKGROUND OF THE INVENTION

Building components such as window and door components and siding utilized in residential and commercial buildings conventionally have been made from hard and soft wood, and metals and metallic alloys such as aluminum and steel. Materials selected for such building components need to possess adequate structural properties to endure normal wear-and-tear and, in the case of outdoor building materials, to withstand changing and sometimes harsh environmental conditions. Additionally, building materials preferably are suitable for painting.

Wood materials are aesthetically desirable because of their decorative wood grain surfaces which provide a natural appearance. Wood may be painted or stained to provide a virtually unlimited variety of colors and finishes. Unfortunately, globalization and high demand have strained the supply of natural resources such as wood, leading to higher material cost. In addition to its high cost, another drawback of wood, especially when used as an outdoor building component, is its susceptibility to natural deterioration and attack by insects and animals.

Metallic building materials, such as metallic windows and door components and metal (e.g., aluminum) siding have found commercial acceptance as a replacement for wood. Metallic building components, however, provide a less aesthetically desirable appearance than grained wood, and are not as suited for painting as wood. Additionally, metal window and door components are inefficient thermal insulators that can cause substantial amounts of heat loss from a building interior.

Polymer-wood composites and plastic materials provide a less expensive alternative to natural wood, and may be formulated to include additives and fillers which impart mechanical properties suited for building component applications. Polymer-wood composites can be used as siding, window coverings and frames, columns, floors, floor underlayment, roof sheathings, ceilings, walls, wall coverings, wainscots, partition systems, doors, and stairs in the construction of homes, offices, and other types of buildings, as well as furniture components, such as chairs, tables, countertops, cabinets, and cabinet doors, and other uses, such as bulletin boards, for example.

U.S. Pat. Nos. 5,486,553 and 5,539,027, both entitled “Advanced Polymer/Wood Composite Structural Member” to Deaner et al. disclose the formation of structural members from a polymer-wood composite. The composites contain, for example, 30 to 50 wt % sawdust along with 50 to 70 wt % polyvinylchloride (PVC) polymer.

One drawback of articles made from or possessing a coating of PVC or PVC-wood composite is the difficulty of replicating a wood grain pattern or other naturally occurring pattern (e.g., granite or stone) in the article surface. The present inventors have proposed laser marking designs such as wood grain patterns into the surfaces of PVC articles.

Lasers have been employed to create identification marks, such as UPC barcodes, in products for managing inventories and tracking shipments of goods, and for providing point of sale pricing information. However, laser marking of polyvinylchloride (PVC) articles in particular can cause localized thermal degradation of the article in the form of discoloration. Typically, high energy exposure of a PVC article to a laser beam will mar the article with a yellowish or reddish tint. It is generally believed that the mechanism which causes the discoloration is “zip dehydrochlorination.” Thermal treatment of PVC with a laser causes evolution of hydrogen chloride, due to elimination of the hydrogen chloride from the PVC backbone. As the hydrogen chloride is eliminated, conjugated polyene sequences of more than four double bonds form in the backbone. The resulting conjugated polyenes are highly reactive and prone to crosslink or cleave the polymer chain. The formation of conjugated polyenes is accelerated by the eliminated hydrochloric acid. The conjugated polyenes are chromophores capable of selective light absorption, and can produce discoloration of organic compounds such as PVC.

### SUMMARY OF THE INVENTION

According to a first aspect of the invention, there is provided a laser-markable PVC composition which is adapted to undergo reduced or no color change in response to irradiation with a laser beam. The composition features polyvinylchloride and at least one discoloration control additive present in an effective amount to reduce or eliminate discoloration that otherwise would be caused by laser marking the polyvinylchloride of the composition, i.e., without the discoloration control additive.

A second aspect of the invention provides a method of laser marking an article, in which a laser-markable PVC surface of the article is irradiated with a laser beam to laser mark the surface and form a mark discernible to the naked eye, while either controlling color change of the surface or substantially reducing or eliminating discoloration of the laser-marked surface.

A third aspect of the invention resides in a PVC article having a laser-marked surface with either controlled coloration or significantly reduced or no discoloration.

These and other aspects of the invention will become more apparent from the accompany drawings and the following detailed description of exemplary embodiments of the invention.

### BRIEF DESCRIPTION OF THE DRAWINGS

The accompanying drawings are incorporated in and constitute part of the specification. The drawings, together with the general description given above and the detailed description of the exemplary embodiments and methods given below, serve to explain the principles of the invention. In such drawings:

FIG. 1 is a schematic view of a system for marking the surface of a PVC material according to an embodiment of the invention; and

FIG. 2 is a schematic view of a system for marking the surface of a PVC material according to another embodiment of the invention.

### DETAILED DESCRIPTION OF EXEMPLARY EMBODIMENTS OF THE INVENTION

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the exemplary embodiments and methods.

Examples of polyvinylchloride (PVC)-composite compositions that may be modified with a discoloration control agent according to exemplary embodiments of the invention for the purpose of controlling color change or substantially reducing or eliminating discoloration are disclosed in, for example, U.S. Pat. Nos. 5,486,553 and 5,539,027. In exemplary embodiments of the invention PVC is present at least in a laser-markable surface region of the article, although the PVC may be distributed throughout the entire body of the article to be marked, i.e., part or the entirety of the article may include the PVC composition. For example, the article may comprise a compilation of a PVC part/section and a PVC-free part/section, such as a PVC coating over a non-PVC core body. PVC coatings may be extruded onto the non-PVC part/section or may be co-extruded with the non-PVC part/section, depending upon the nature of the non-PVC material and its ability to be co-extruded with PVC. PVC coatings can also be applied using, for example, spray, dip, molding, and other coating techniques.

The PVC composition may contain one or more polymers and other materials in addition to PVC. In a particularly exemplary embodiment, the composition is a composite of PVC polymer and cellulosic fibers or particles, such as wood fiber, wood flour and sawdust. Additionally, the composition may contain other ingredients known in the art and/or advantageous for its intended use, such as modifiers, lubricants, fillers, foaming agents, and processing aids.

According to a first embodiment of the invention, a laser-markable composition includes polyvinylchloride and a hydrogen chloride scavenger. The hydrogen chloride scavenger reacts with hydrogen chloride which is generated or evolved due to polyvinylchloride dechlorination caused by laser irradiation. The hydrogen chloride scavenger may be included in an effective amount to eliminate or at least substantially reduce discoloration caused by the evolved hydrogen chloride. The effective amount will vary, depending upon the scavenger selected. The scavenger may be heat activated by the laser. The scavenger may be distributed throughout the PVC article, or the scavenger may be included exclusively in the PVC surface layer or coating region which is to be laser marked. Calcium carbonate is an example of a suitable scavenger, and may be incorporated in the composition in an amount of about 5 per hundred part of resin (phr) to about 35 phr or beyond this range. Another example is epoxidized soybean oil. An effective amount of epoxidized soybean oil may range, for example, from about 2.0 to about 27.0 phr or beyond this range.

A second embodiment of the invention provides a laser-markable composition including polyvinylchloride and an antioxidant. It is believed that antioxidants scavenge free radicals and suppress peroxides formation from attack of oxygen, particularly at elevated temperatures. The antioxidant may be present in the laser-markable surface area of the article in an effective amount to eliminate or substantially reduce discoloration caused by laser irradiation. The effective amount will vary, depending upon the antioxidant selected. The antioxidant may be distributed throughout the PVC article or may be limited to the PVC surface layer or coating of the article. An example of antioxidant is octadecyl-3-(3,5-ditertbutyl-4-hydroxyphenyl)-propionate (commercially available as Irganox 1076 produced by Ciba-Geigy), which may be present in an amount of for example, about 0.1 to about 0.4% dry weight of PVC formula.

According to a third embodiment of the invention, a laser-markable composition includes polyvinylchloride and a heat stabilizing agent for managing heat development when the composition is exposed to a laser. The heat stabilizing agent may be present in the laser-markable surface area of the article in an effective amount to eliminate or substantially reduce the discoloration caused by the heat of laser irradiation. The effective amount will vary, depending upon the heat stabilizing agent selected. The heat stabilizing agent may be distributed throughout the PVC article or may be limited to the PVC surface layer or coating of the article. An example of a heat stabilizing agent suitable for this embodiment is tin stabilizers, such as butyl tin mercapttide, which may be used in an amount of, for example, about 0.5 to about 2.5 phr or beyond this range. Another example of a heat stabilizing agent is benzotriazole, which may be present, for example, in an amount of about 2 to about 10 phr or beyond this range.

A fourth embodiment of the invention provides a laser-markable composition containing polyvinylchloride and a laser-activated color control agent for controlling the color change brought about by laser marking the formulation. The color control agent is activated by laser irradiation to change color and impart a desired color upon irradiating the laser-marked area. The color control agent may be included in the irradiated area only or in non-irradiated areas as well. The color control agent may be selected to provide the irradiated area with a color that is the same as or different from the color of the non-irradiated area. In one exemplary implementation of the fourth embodiment, the color control agent may be selected to mask the PVC discoloration that accompanies laser irradiation, so that the laser-marked area of the PVC article is substantially indistinguishable in color from non-marked areas of the article. Alternatively, the color control agent may be selected to provide a desired color change covering the laser-marked area to create a visually distinguishable yet desired color that differs from the color of the surrounding non-marked areas of the article. The color control agent may be distributed throughout the PVC article or may be restricted to a laser-marked area of the surface layer or coating of the article. Iron oxide, dyes and pigments are examples of color control agents for controlling the color of the irradiated article. For example, titanium dioxide in an amount of, e.g., about 5 to about 10 phr or beyond this range may be selected. Mica may be selected as filler, for example, in an amount of about 5 to about 35 phr or beyond this range. Heat sensitive inorganic iron oxide may be present in an amount of, for example, about 1 to about 15% dry weight of laser active coating formulation.

Combinations of the above first to fourth embodiments may also be practiced. The laser-markable composition may contain a combination of any two or more of the hydrogen chloride scavenger(s) of the first embodiment, the antioxidant(s) of the second embodiment, the heat stabilizing agent(s) of the third embodiment, and the laser-activated color control agent(s) of the fourth embodiment.

The term “laser mark” used herein means to irradiate a PVC article, such as a PVC-wood composite, with a laser beam to form a graphic design. In the course of marking, the laser beam causes a visually perceptible change to the component surface. The change may involve removal, ablation, etching, engraving, or change of color of a coating or the body of the article. The result is a visually-perceptible graphic mark in the article. As used herein, “in the article” includes laser marking the surface of the article, such as changing the article surface without necessarily engraving into the surface.

The terms graphic and graphic design include decorative and artistic designs, non-decorative designs, patterns, graphic images, wood grain, alpha-numeric characters, corporate and trade logos, other identification such as UPC codes, etc.

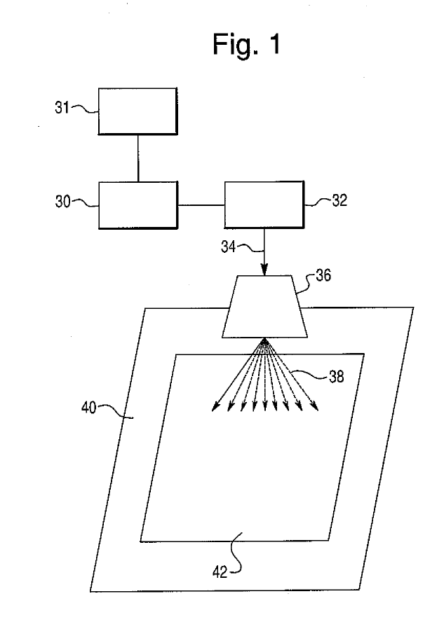

A system for marking components such as building structure components using a high-speed, high-power laser is shown in FIG. 1. The high-power laser is represented by reference numeral 32 in FIG. 1. The output 34 of the laser 32 is coupled to a scanning head 36, which includes a controllable, movable relatively light weight coated mirror that is capable of scanning the laser output at a relatively high speed. The laser output 38 can be scanned across the work piece 42 on working surface 40, such as a table. Work piece 42 may be a building component or other substrate.

The system includes a controller, designated by reference numeral 30 in FIG. 1. Control information for controlling the laser may be stored in advance in the controller 30. The stored control information may be linked to one or many different graphics, e.g., patterns. The controller 30 is capable of keeping up with the high scan speeds produced by the lightweight mirrors and making the necessary power changes at the specified speed. To create fine resolution graphics, the controller makes those power changes at high rates, such as every few millimeters of beam scan. The scan speed of the laser will determine the amount of power changes within the graphic. The type (e.g., complexity and intricacy) and depth of the graphic will also influence how the graphic is marked on the work piece.

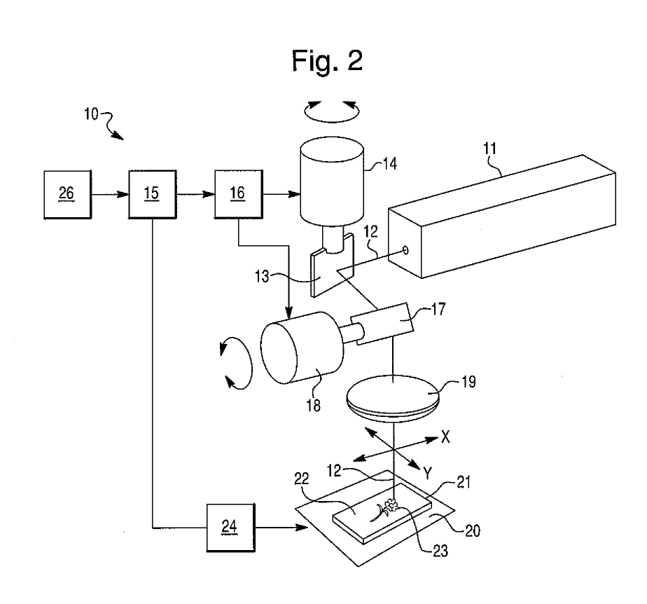

FIG. 2 illustrates another embodiment of a system for marking materials, such as building components. The system, generally designated by reference numeral 10, includes a laser 11 for generating a laser beam 12 in a direction of a computer-controlled mirror system. The illustrated mirror system also includes an x-axis mirror 13 rotatably mounted on and driven by an x-axis galvanometer 14. The x-axis galvanometer 14 is adapted to rotate and cause the rotation of the x-axis mirror 13. Rotation of the x-axis mirror 13 while the laser beam 12 is incident on the mirror 13 causes the laser beam 12 to move along the x-axis. A (numerical) control computer 15 controls the output of a power source 16 to control the x-axis galvanometer's 14 rotation of the x-axis mirror 13. The laser beam 12 is deflected by the x-axis mirror 13 and directed toward a y-axis mirror 17 rotatably mounted on y-axis galvanometer 18. The y-axis galvanometer 18, which is also powered by the power source 16, is adapted to rotate and cause rotation of the y-axis mirror 17. Rotation of the y-axis mirror 17 causes movement of the laser beam 12 incident on mirror 17 along the y-axis. The control computer 15 controls the output of the power source 16 delivered to y-axis galvanometer 18 for controlling rotation of the y-axis galvanometer 18 and the mirror 17.

The laser beam 12 is deflected by the y-axis mirror 17 and directed through a focusing lens 19 adapted to focus the laser beam 12. The lens 19 may be a multi-element flat-field focusing lens assembly, which optically maintains the focused spot on a flat plane as the laser beam 12 moves across the material to laser mark a graphic. The lens 19, mirrors 13, 17 and galvanometers 14, 18 can be housed in a galvanometer block (not shown).

The apparatus 10 further includes a working surface 20 which can be a solid support such as a table, or even a fluidized bed. A PVC material (or work piece) 21 is placed on the working surface 20. The PVC material 21 includes a viewable, laser-markable surface 22 to be laser marked. The working surface 20 can be adjusted vertically to adjust the distance from the lens 19 to the laser-markable surface 22 of the PVC material 21. The laser beam 12 is directed by the mirrors 13, 17 against the laser-markable surface 22 of the PVC material 21. Usually the laser beam 12 is directed generally perpendicular to the laser-markable surface 22, but different graphics can be achieved by adjusting the angle between the laser beam 12 and the laser-markable surface 22, for example, from about 45° to about 135°. Relative movement between the laser beam 12 in contact with the laser-markable surface 22 of the PVC material 21 causes a graphic design 23 to be scribed on the PVC laser-markable surface 22. The movements and timing of the mirrors 13, 17 and the power of the laser beam 12 are controlled by the numerical control computer 15 to scribe the specific desired graphic 23. As referred to herein, relative movement may involve movement of the laser beam 12 (e.g., using the mirror system) as the PVC material 21 remains stationary, movement of the PVC material 21 while the laser beam 12 remains stationary, or a combination of simultaneous movement of the laser beam 12 and the PVC material 21 in different directions and/or at different speeds.

A second computer such as a work station computer (31 in FIG. 1; 26 in FIG. 2) can be used in the method to facilitate the formation of the desired graphic.

According to an implementation, the graphic design to be laser marked in the work pieces is created using Adobe® Illustrator, or any similar vector based rendering program. Generally, the features that are etched using vector-based programs include lines and curves that define the outlines of the graphic and its major linear and curved features. The vector-based rendering program AutoCAD® developed by AutoDesk®, Inc. may be employed for this task. In order to make special features such as contour fills that are either difficult or impossible to prepare with AutoCAD®, the additional vector-based program Cutting Shop of Arbor Image Corp. may be used. Cutting Shop is a commercially available product of Arbor Image Corp. promoted for cutting and engraving applications. The raster-based program Technoblast® from Technolines LLC can create computer readable instructions for controlling the laser path and power for marking certain features. The raster- and vector-based program Exodus is used to rip the files received TechnoBlast programs into a .tbf graphic (raster) file for the laser controller. Lasers are typically equipped with appropriate software to convert computer files into the laser manufacturer's language.

According to an exemplary implementation, a graphic image is scanned or otherwise input into the work station computer, converted into the proper format, e.g., digitized, and digital information corresponding to the lased features of the graphic image is introduced into the control computer with instructions to laser mark graphic design sections into their corresponding elements. The control computer controls movement of the galvanometers 14, 18 and the associated mirrors 13, 17 and the power output of the laser 11 to mark the first graphic element on the working surface of the work piece 21 at the appropriate power, movement velocity for high throughput, and beam spot site. At the same time, controllers and the workstation coordinate the relative movement and output of the laser with the movement of the article along the support 20. The laser controller will also control transverse movement of the laser beam. The power, beam size, and scan speeds may be selected depending upon the work piece material and intricacy of the graphic design. Tt may be preferable to avoid undesirable consequences of over-treatment, such as complete carbonization, burn-through and/or melting of the work piece, or under-treatment where the graphic image is not visible or only partially visible. The system can also include a tank 24 to inject a gas such as an inert gas into the working zone for cooling purposes. The amount of gas can be controlled by the work station computer 26, 31, laser controller, or other apparatus.

The work station computer 26, 31 may be, for example, a personal computer system. Computer hardware and software for carrying out the embodiments of the invention described herein may be any kind, e.g., either general purpose, or some specific purpose such as a workstation. The computer may be a Pentium® class or multi-core processor computer, running for example Windows XP®, Windows Vista®, or Linux®, or may be a Macintosh® computer. The computer may also be a handheld computer, such as a PDA, cellphone, or laptop. The programs may be written in C, or Java, Brew or any other programming language. The programs may be resident on a storage medium, e.g., magnetic or optical, of, e.g., the computer hard drive, a removable disk or media such as a memory stick or SD media, or other removable medium. The programs may also be run over a network, for example, with a server or other machine sending signals to one or more local machines, which allows the local machine(s) to carry out the operations described herein.

It should be understood that methods of the present invention may be carried out using various other laser systems having alternative layouts and components to those shown in FIGS. 1 and 2.

From the above description, it will be understood that certain exemplary embodiments of the invention feature the patterning of articles with graphic designs laser engraved or otherwise laser marked in the component in such a way that the graphic design is viewable. The graphic may describe a pattern that is repeating such as a diamond, houndstooth or chevron pattern, for example, or may describe a non-repeating pattern that is organic, floral and/or natural in such a way that it does not repeat. The patterns and graphics may be as simple as geometric designs or highly complex. The inventive concept may permit the laser marking of advanced, highly aesthetic designs to allow manufacturers to offer premium products not now available in the marketplace.

Additional advantages and modifications will readily occur to those skilled in the art. Therefore, the invention in its broader aspects is not limited to the specific details, representative devices and methods, and illustrative examples shown and described.

What is claimed is:

1. A laser-markable polyvinylchloride composition which is adapted to undergo reduced or no color change in response to irradiation with a laser beam, the composition comprising:
polyvinylchloride; and
a discoloration control additive present in an effective amount to reduce or eliminate discoloration caused by laser marking of the polyvinylchloride composition.

2. The laser-markable polyvinylchloride composition of claim 1, wherein the discoloration control additive comprises a hydrogen chloride scavenger.

3. The laser-markable polyvinylchloride composition of claim 1, wherein the discoloration control additive comprises an antioxidant.

4. The laser markable polyvinylchloride composition of claim 1, wherein the discoloration control additive comprises a heat stabilizing agent.

5. The laser markable polyvinylchloride composition of claim 1, wherein the discoloration control additive comprises a color control agent.

6. The laser-markable polyvinylchloride composition of claim 1, wherein the article is an exterior building component.

7. The laser-markable polyvinylchloride composition of claim 1, wherein the laser-marked article is selected from the group consisting of doors and door components, window components, siding, decking and fencing.

8. A method of making a laser-marked PVC article comprising:
providing a laser-markable polyvinylchloride composition comprising polyvinylchloride and a discoloration control additive present in an effective amount to reduce or eliminate discoloration caused by laser irradiation; and
laser marking the laser-markable polyvinylchloride composition with a laser.

9. The method of claim 8, wherein the discoloration control additive comprises a hydrogen chloride scavenger.

10. The method of claim 8, wherein the discoloration control additive comprises an antioxidant.

11. The method of claim 8, wherein the discoloration control additive comprises a heat stabilizing agent.

12. The method of claim 8, wherein the discoloration control additive comprises a color control agent.

13. The method of claim 8, wherein the laser-marked article is selected from the group consisting of doors and door components, window components, siding, decking and fencing.

14. A laser-marked article formed from a laser-markable polyvinylchloride composition comprising polyvinylchloride and a discoloration control additive present in an effective amount to reduce or eliminate discoloration caused by laser marking of the polyvinylchloride composition.

15. The laser-marked article of claim 14, wherein the discoloration control additive comprises a hydrogen chloride scavenger.

16. The laser-marked article of claim 14, wherein the discoloration control additive comprises an antioxidant.

17. The laser-marked article of claim 14, wherein the discoloration control additive comprises a heat stabilizing agent.

18. The laser-marked article of claim 14, wherein the discoloration control additive comprises a color control agent.

19. The laser-marked article of claim 14, wherein the laser-marked article is an exterior building component.

20. The laser-marked article of claim 14, wherein the laser-marked article is selected from the group consisting of doors and door components, window components, siding, decking and fencing.
